(19) United States
(12) Patent Application Publication
(10) Pub. No.: US 2023/0062009 A1
(43) Pub. Date: Mar. 2, 2023

(54) EXPERIMENTAL ANIMAL RESTRAINER APPLICABLE TO VARIOUS DRUG ADMINISTRATION METHOD

(71) Applicant: PLASBIO Co.,Ltd, Jeonju-si (KR)

(72) Inventors: Sung Gurl PARK, Daejeon (KR); Tae Geon OH, Jeonju-si (KR); Sun Wha LIM, Jeonju-si (KR); So Ra PARK, Jeonju-si (KR)

(73) Assignee: PLASBIO Co.,Ltd, Jeonju-si (KR)

(21) Appl. No.: 17/564,904

(22) Filed: Dec. 29, 2021

Related U.S. Application Data
(63) Continuation of application No. PCT/KR2021/020033, filed on Dec. 28, 2021.

(30) Foreign Application Priority Data
Aug. 25, 2021 (KR) 10-2021-0112458

(51) Int. Cl. A01K 1/03; A61D 7/04

(52) U.S. Cl. CPC A01K 1/031; A61D 7/04

(57) ABSTRACT

Provided is an experimental animal restrainer applicable to various drug administration methods, as an experimental animal restrainer that can be used for intrathecal administration, intravenous administration and intratracheal administration only by replacing some components. There is an advantage of being used to administer drug substances to experimental animals by various methods only through the experimental animal restrainer even without using the experimental animal restrainer applicable only to each administration method.

### CROSS-REFERENCE TO RELATED APPLICATIONS

This application is a Continuation of International Application No. PCT/KR2021/020033 filed Dec. 28, 2021, which claims benefit of priority to Korean Patent Application No. 10-2021-0112458 filed Aug. 25, 2021, the entire content of which is incorporated herein by reference.

### BACKGROUND OF THE INVENTION

### Field of the Invention

The present disclosure relates to an experimental animal restrainer applicable to various drug administration methods, and more particularly, to an experimental animal restrainer comprising a base; a support of which one end is hinged to one side of the base so as to be rotatable with the base; a fixing plate hinged to the other end of the support to be rotatable; a lower plate of which one side is coupled to the fixing plate; an upper plate of which one side is coupled to the other side of the lower plate and the other side is placed with an experimental animal with a tail; and a hollow anesthetic port positioned on the upper portion of the upper plate and an anesthetic port fixing part for fixing the anesthetic port to the upper plate.

### Description of the Related Art

Toxicity tests that apply unknown chemical substances for which safety is not secured to laboratory animals are indispensable not only for scientific research, but also for clinical trials by securing the safety of the corresponding substances. In fields of new drug development and basic research, experimental animals are used for various purposes, and as research objects and subjects vary, various types of restrainers to be applied to experiments of experimental animal models have been variously proposed.

In general, intravenous injection has many advantages as compared to other routes. As a drug reaches a required tissue of a body through the heart within seconds, a drug effect appears quickly, and the response is also clearly shown as much as that. When water may not be orally administered sufficiently, it is possible to supply water or salt and other required electrolytes, or to inject drugs such as an antidote and the like into the blood including blood supply after bleeding, or to expect rapid drug effects.

Intrathecal injection is a method of administering a drug directly into the cerebrospinal fluid of the subarachnoid space. In the case of drugs that selectively act on the central nervous system clinically, the intrathecal injection has been widely used by not only reducing the side effects of systemic injection, but also inducing a maximum therapeutic effect on drugs with low brain-blood barrier permeability. Intratracheal injection means direct injection of a drug substance into the trachea, and is widely used in animal experiments to test for respiratory toxicity of substances as an alternative to inhalation. As such, although there are various drug administration methods, experimental animal restrainers that have been currently used in laboratories are designed to be suitable for a specific drug administration method, and thus, have a disadvantage in that it is impossible to be applied to other drug administration methods.

The above-described technical configuration is the background art for helping in the understanding of the present invention, and does not mean a conventional technology widely known in the art to which the present invention pertains.

### SUMMARY OF THE INVENTION

Therefore, an object of the present disclosure is to provide an experimental animal restrainer that is easily stored and applicable to various drug administration methods.

The present disclosure relates to an experimental animal restrainer that is easily stored and applicable to various drug administration methods. According to an embodiment of the present disclosure, the experimental animal restrainer may include a base; a support of which one end is hinged to one side of the base so as to be rotatable with the base; a fixing plate hinged to the other end of the support to be rotatable; a lower plate of which one side is coupled to the fixing plate; an upper plate of which one side is coupled to the other side of the lower plate and the other side is placed with an experimental animal with a tail; and a hollow anesthetic port positioned on the upper portion of the upper plate or the lower plate and an anesthetic port fixing part for fixing the anesthetic port to the upper plate or the lower plate.

The support and the fixing plate may be folded at 180° with respect to the base plane.

The experimental animal restrainer may further include a fixing part coupled with the upper plate to restrain the experimental animal placed on the upper plate.

The fixing part coupled with the upper plate to restrain the experimental animal placed on the upper plate may include a jacket covering the body of the experimental animal and a boa system for contacting the jacket with the upper plate.

The boa system may include a string and a dial, a part of the string may be fixed to the upper plate, and the other part may be fixed to the upper plate by a string fixing part.

The experimental animal restrainer may further include a clip for protecting the abdomen of the experimental animal which is positioned at an opposite side to the anesthetic port and coupled to the end of the upper plate or the lower plate.

The hollow anesthetic port positioned at the upper center of the upper plate may include one or more anesthetic gas inlets and one anesthetic gas outlet, and the anesthetic gas outlet may further include a head cover having a parabolic shape, a scoop shape or a dish shape capable of covering the head of the experimental animal.

The anesthetic port fixing part for fixing the anesthetic port to the upper plate may include a coupling part capable of being coupled to the upper plate or the lower plate; and an anesthetic port coupling part vertically fixed to the coupling part to fix the anesthetic port.

The experimental animal restrainer may further include an opening device positioned below the anesthetic port to open the mouth of the experimental animal.

The upper plate or lower plate of the experimental animal restrainer may further include a vertical groove for fixing the opening device, and the opening device may include a rod-shaped tooth fixture for fixing the teeth of the experimental animal; a tooth fixture coupling part for fixing the tooth fixture to the upper plate or the lower plate; and a tooth fixture support positioned at both sides of the tooth fixture and disposed at the coupling part.

The experimental animal restrainer may further include a tail holder positioned at an opposite side to the anesthetic port and fixed to the upper plate or the lower plate to fix the tail of the experimental animal.

One side of the tail holder may include a tail holder fixing part for fixing the tail holder to the upper plate or the lower plate; and the other side may include a tail fixing part that protrudes in an opposite direction to the tail holder fixing part and has a groove in which the tail of the experimental animal is positioned.

The experimental animal restrainer may be used for intravenous injection, intrathecal injection and intratracheal injection.

The experimental animal restrainer of the present disclosure is an experimental animal restrainer that can be used for intrathecal administration, intravenous administration and intratracheal administration only by replacing some components. There is an advantage of being used to administer drug substances to experimental animals by various methods only through the experimental animal restrainer even without using the experimental animal restrainer applicable only to each administration method.

The effects of the present disclosure are not limited to the above-described effects, and it will be understood that provisional effects toe expected by technical features of the present disclosure will be apparent from the following description.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a used state diagram of an experimental animal restrainer of the present disclosure in intravenous injection;

FIG. 2 is a used state diagram of an experimental animal restrainer of the present disclosure in intrathecal injection;

FIG. 3 is a used state diagram of an experimental animal restrainer of the present disclosure in intratracheal injection;

FIGS. 4A to 4C illustrate a base 10, a support 20, and a fixing plate 30 of the present disclosure;

FIG. 4D illustrates a folding process of the experimental animal restrainer of the present disclosure;

FIGS. 5A to 5C illustrate exploded diagrams of an experimental animal restrainer according to an embodiment of the present disclosure;

FIG. 6 illustrates an upper plate of an experimental animal restrainer according to an embodiment of the present disclosure;

FIG. 7 illustrates a lower plate of an experimental animal restrainer according to another embodiment of the present disclosure;

FIG. 8 illustrates an upper plate of the experimental animal restrainer according to another embodiment of the present disclosure;

FIGS. 9A to 9E are diagrams illustrating a fixing part 60 for restraining an experimental animal on the upper plate;

FIG. 10 illustrates A) an anesthetic port 70 and a head cover 71, B) an anesthetic port fixing part 80, C) an anesthetic port 70′ of another embodiment, and D) head covers 71′ and 71″ of another embodiment;

FIG. 11 illustrates an opening device 100 for opening the mouth of an experimental animal; and

FIG. 12 illustrates tail holders 120 and 120′ capable of fixing the tail of the experimental animal.

### DETAILED DESCRIPTION OF THE PREFERRED EMBODIMENT

The present disclosure relates to an experimental animal restrainer that is easily stored and applicable to various drug administration methods. According to an embodiment of the present disclosure, the experimental animal restrainer may include a base; a support of which one end is hinged to one side of the base so as to be rotatable with the base; a fixing plate hinged to the other end of the support to be rotatable; a lower plate of which one side is coupled to the fixing plate; an upper plate of which one side is coupled to the other side of the lower plate and the other side is placed with an experimental animal with a tail; and a hollow anesthetic port positioned on the upper portion of the upper plate or the lower plate and an anesthetic port fixing part for fixing the anesthetic port to the upper plate or the lower plate.

In this specification, a case where a part “comprises” an element will be understood to imply the inclusion of stated elements but not the exclusion of any other elements unless explicitly described to the contrary.

Hereinafter, the present disclosure will be described in more detail with reference to the accompanying drawings.

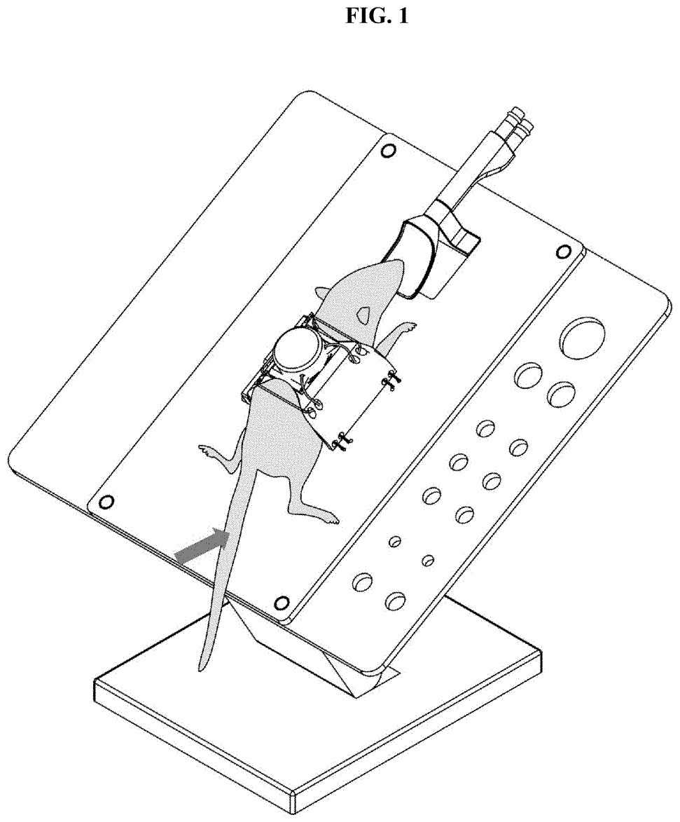

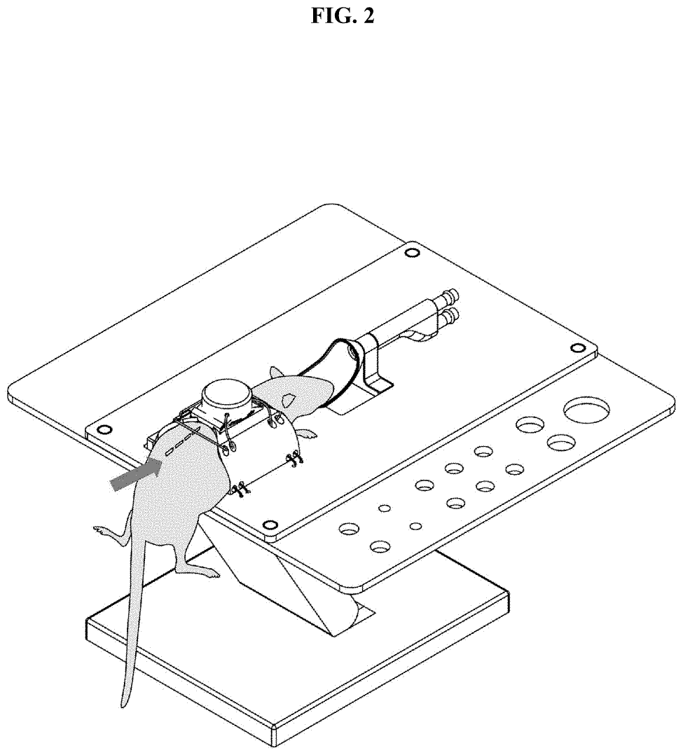

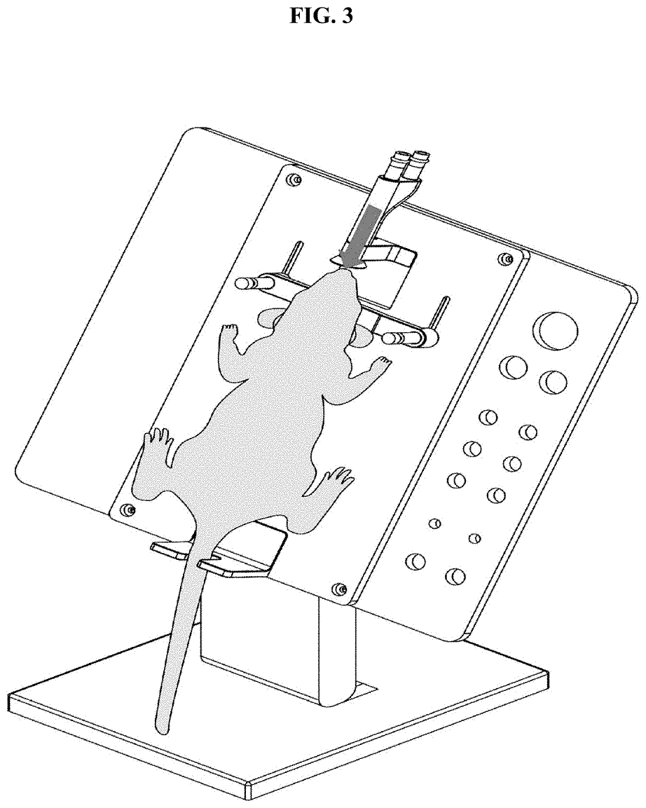

FIGS. 1 to 3 are diagrams illustrating used state diagrams of the present disclosure. FIG. 1 is a used state diagram of an experimental animal restrainer of the present disclosure in intravenous injection, FIG. 2 is a used state diagram of an experimental animal restrainer of the present disclosure in intrathecal injection, and FIG. 3 is a used state diagram of an experimental animal restrainer of the present disclosure in intratracheal injection. An arrow indicated in each drawing indicate a position at which a substance to be administered is administered to an experimental animal.

An experimental animal restrainer of the present disclosure is an experimental animal restrainer that can be used for intrathecal administration, intravenous administration and intratracheal administration only by replacing some components. There is an advantage of being used to administer drug substances to experimental animals by various methods only through the experimental animal restrainer even without using the experimental animal restrainer applicable only to each administration method.

In specific embodiment, the experimental animal restrainer of the present disclosure includes a base 10; a support 20 of which one end is hinged to one side of the base so as to be rotatable with the base; a fixing plate 30 hinged to the other end of the support to be rotatable; a lower plate 40 of which one side is coupled to the fixing plate; upper plates 50, 51, and 52 of which one side is coupled to the other side of the lower plate and the other side is placed with an experimental animal with a tail; and a hollow anesthetic port 70 positioned on the upper center of the upper plate and an anesthetic port fixing part 80 for fixing the anesthetic port to the upper plate.

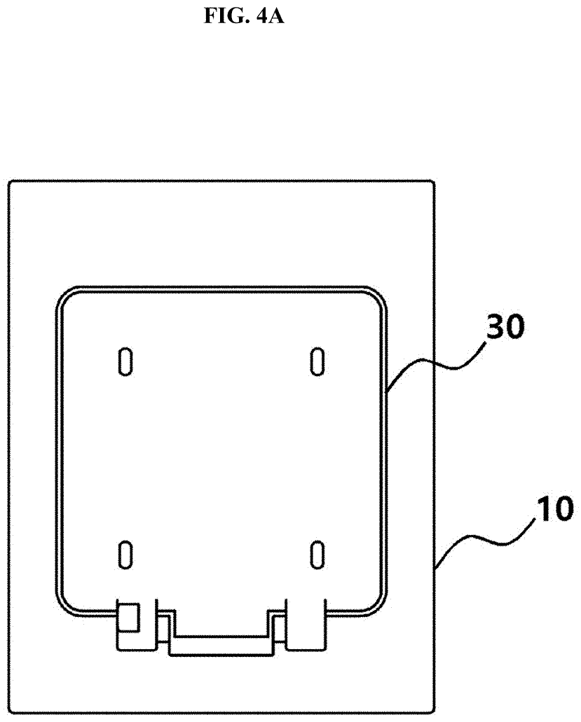

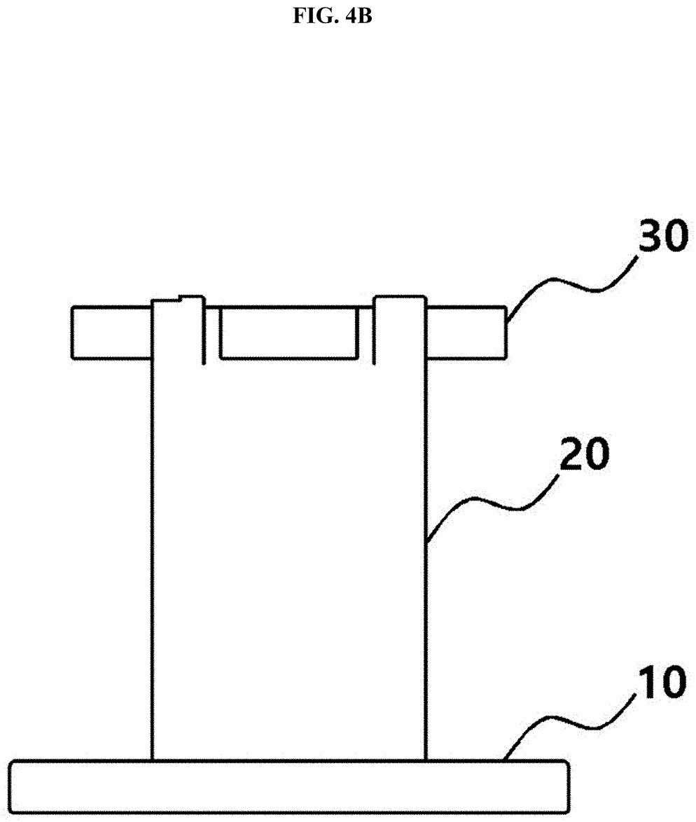

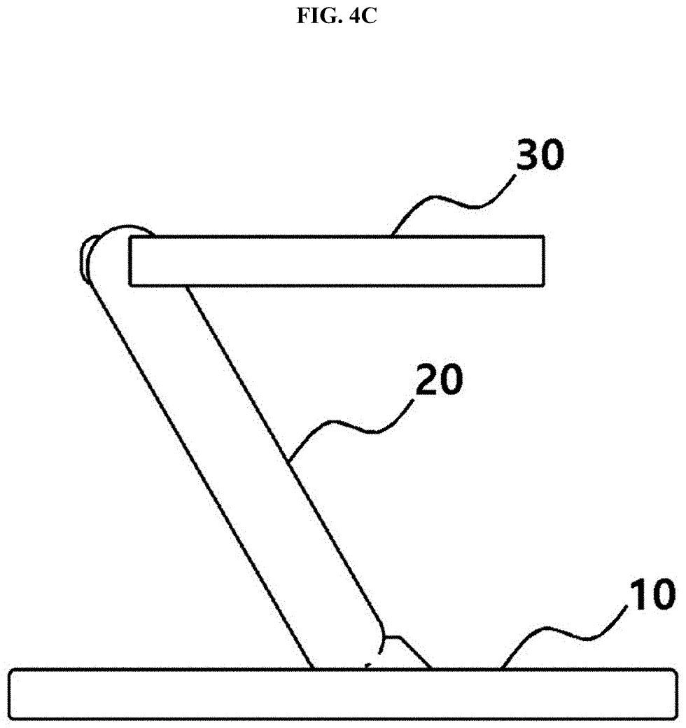

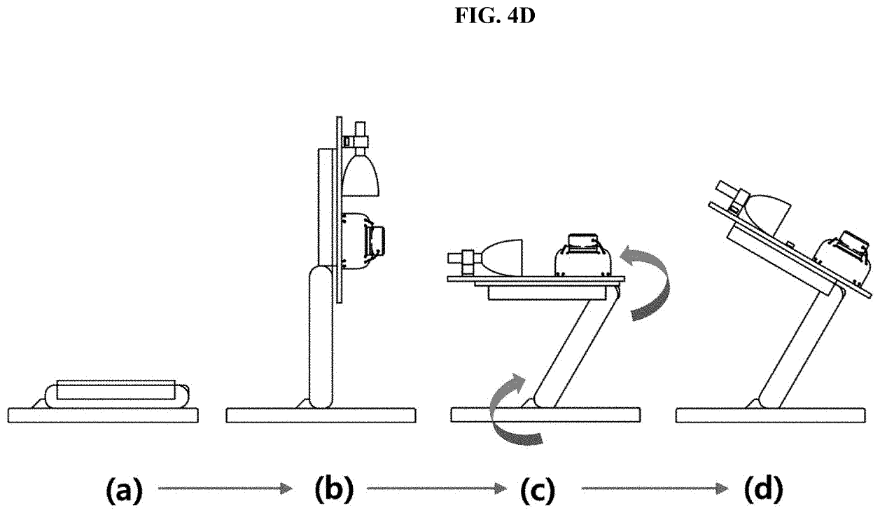

FIGS. 4A to 4C illustrate the base 10, the support 20, and the fixing plate 30 of the present disclosure.

The base 10 is placed on the ground or on an experimental table and used for supporting the experimental animal restrainer of the present disclosure. The support 20 may be coupled to one side of the base 10, that is, a side opposite to the surface in contact with the ground, and one end of the support 20 may be coupled to a central portion of the base 10.

The support 20 may be hinged (not illustrated) to the base 10 to be tilted at a predetermined angle and more preferably, the support 20 may be folded at 1800 with respect to the base 10 plane. Accordingly, an experimenter may perform the experiment while adjusting an inclination of the support 20 according to an administration method.

The fixing plate 30 may be hinged to the other end of the support 20 so as to be rotatable. The other end of the support 20 is preferably hinged to one end of the fixing plate 30 so as to be rotatable. More preferably, the fixing plate 30 may be folded at 180° with respect to the plane of the base 10. Accordingly, the experimenter may perform the experiment while adjusting an inclination of the fixing plate 30 according to an administration method.

FIG. 4D illustrates a folding process of the experimental animal restrainer of the present disclosure. FIG. 4D (a) is a storage state diagram when the experimental animal restrainer is not used, and there is an advantage that it is easy to be stored due to a small volume while the base 10, the support 20, and the fixing plate 30 are in contact with each other. FIG. 4D (b) illustrates a diagram of a state in which the support 20 and the fixing plate 30 are unfolded at 90° with respect to the base 10. FIG. 4D (c) illustrates a state in which the fixing plate 30 is disposed in parallel with the base 10, and mainly, in intrathecal injection, the experimental animal restrainer of the present disclosure may be disposed in such a state. At this time, the support 20 is inclined at a predetermined angle with respect to the base 10 and the fixing plate 30. FIG. 4D (d) illustrates a state in which the fixing plate 30 is inclined at a predetermined angle with respect to the base 10, and mainly, in intravenous injection or intratracheal injection, the experimental animal restrainer of the present disclosure may be disposed in such a state.

In relation to the hinging of connecting the base 10 and the support 20 and the support 20 and the fixing plate 30, various known techniques may be applied, and thus, detailed description thereof will be omitted.

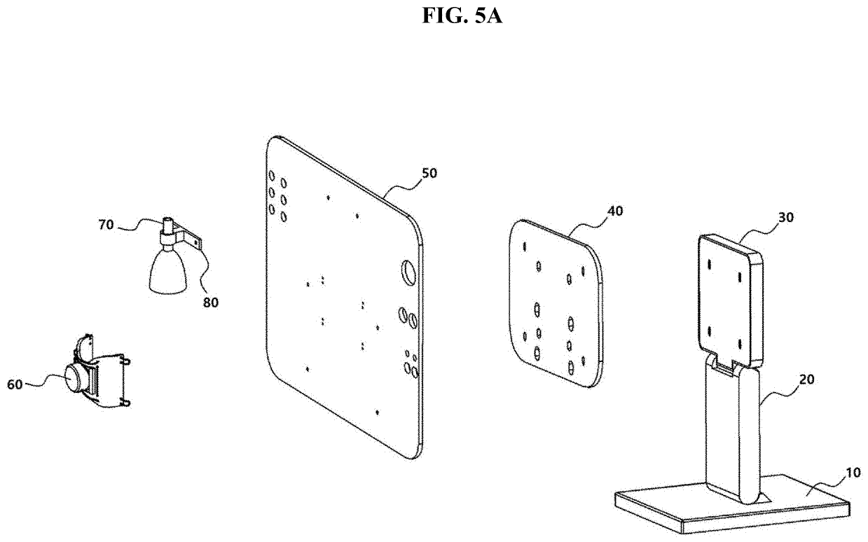

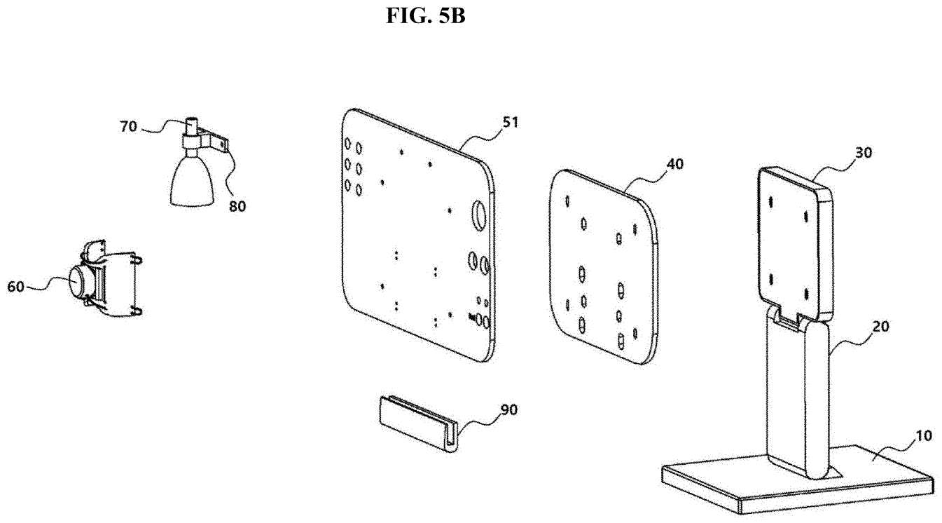

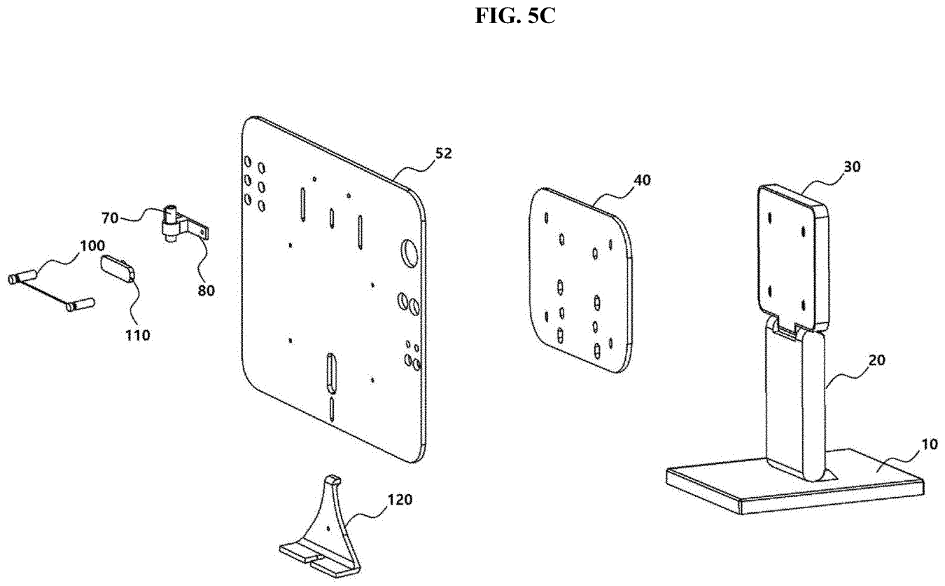

FIGS. 5A to 5C illustrate exploded diagrams of an experimental animal restrainer according to an embodiment of the present disclosure. FIG. 5A illustrates an experimental animal restrainer which may be used in intravenous injection, FIG. 5B illustrates an experimental animal restrainer which may be used in intrathecal injection, and FIG. 5C illustrates an experimental animal restrainer which may be used in intratracheal injection.

According to yet another embodiment of the present disclosure, the experimental animal restrainer may further include a fixing part 60 which is coupled to the upper plate to restrain the experimental animal placed on the upper plate.

The lower plate 40 may be coupled to one side of the fixing plate 30, and the upper plates 50, 51, and 52 may be coupled to the other side of the lower plate 40. The lower plate 40 serves as an intermediate medium for coupling the upper plates 50, 51, and 52 and the fixing plate 30.

One side of the lower plate 40 may include a coupling protrusion for coupling with the fixing plate 30, and the fixing plate 30 may include a coupling groove in a portion corresponding to the coupling protrusion of the lower plate 40.

In addition, one side of each of the upper plates 50, 51, and 52 may include a coupling protrusion for coupling with the lower plate 40, and the lower plate 40 may include a coupling groove at a portion corresponding to the coupling protrusion of each of the upper plates 50, 51, and 52. That is, the coupling protrusion for coupling with the fixing plate 30 in the lower plate 40 and the coupling groove corresponding to the coupling protrusion of each of the upper plates 50, 51, and 52 are formed on opposite sides to each other.

The position, shape, and size of the coupling protrusion and the coupling groove are not particularly determined, and may be variously applied in consideration of coupling strength, manufacturing process, and the like. The coupling may be screw coupling or coupling using a magnet. In this case, at least one of the lower plate 40 and the fixed plate 30 may include a magnet in a corresponding portion, and the other may include a metal piece. When both the lower plate 40 and the fixed plate 30 include magnets, it is preferable to include magnets having different polarities.

One side of each of the upper plates 50, 51, and 52 may be coupled to the other side of the lower plate, and an experimental animal with the tail may be placed on the other side of each of the upper plates 50, 51 and 52. The experimental animal is preferably a laboratory mouse. The sizes and designs of the upper plates 50, 51, and 52 may vary depending on an administration method, and specific structural features of the upper plates 50, 51, and 52 according to an administration method will be described below.

FIG. 5A is an exploded diagram of the experimental animal restrainer which may be used in intravenous injection, wherein in addition to the upper plate 50, the fixing part 60 capable of fixing the experimental animal in intravenous injection, and the anesthetic port 70 for supplying anesthetic gas and the anesthetic port fixing part 80 for anaesthetizing the experimental animal may be used together.

FIG. 5B is an exploded diagram of the experimental animal restrainer which may be used in intrathecal injection, wherein in addition to the upper plate 51, the fixing part 60 capable of fixing the experimental animal in intrathecal injection, and the anesthetic port 70 for supplying anesthetic gas, the anesthetic port fixing part 80, and a clip 90 for protecting the abdomen of the experimental animal for anaesthetizing the experimental animal may be used together.

FIG. 5C is an exploded diagram of the experimental animal restrainer which may be used in intratracheal injection, wherein in addition to the upper plate 52, the anesthetic port 70 for supplying anesthetic gas, the anesthetic port fixing part 80, an opening device 100, a head support 110 of the experimental animal, and a tail holder 120 of the experimental animal for anaesthetizing the experimental animal may be used together.

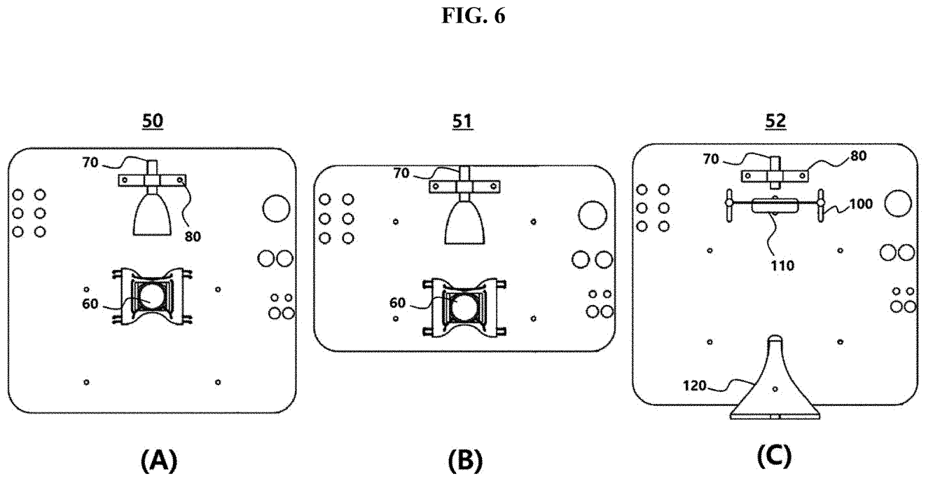

Hereinafter, with reference to FIG. 6, the upper plates 50, 51, and 52 of the present disclosure will be described in detail.

FIG. 6A illustrates the upper plate 50 that may be used in intravenous injection. In the case of experimental mice, intravenous injection is performed through the tail. Therefore, unlike intrathecal injection, only the tail is sufficient to hang to the end of the upper plate 50. Therefore, it is preferable that the hip portion of the experimental animal is positioned at the end of the upper plate 50, and a vertical length of the upper plate 50 that may be used in intravenous injection may be formed to be longer than the vertical length of the upper plate 51 that may be used in intrathecal injection.

FIG. 6B illustrates the upper plate 51 that may be used in intrathecal injection. The upper plate 51 is characterized in that the vertical length is shorter than that of the upper plates 50 and 52 that may be used in intravenous injection or intratracheal injection. In intrathecal injection, the abdomen of the experimental animal hangs to the end of the upper plate 51, and then spine portions L2 and L3 of the experimental animal are opened, and a substance to be injected is administered into the opened portion through a needle (see FIG. 24.

According to the characteristics of the administration method, the upper plate 51 is designed to have a short vertical length. The vertical length of the upper plate 51 is 170 to 210 mm, more preferably 190 to 200 mm.

Since the upper plate 51 that may be used in the intrathecal injection hangs to the end of the upper plate 51 of the experimental animal, the clip 90 for protecting the abdomen of the experimental animal capable of protecting the abdomen of the experimental animal may be used together. The clip 90 for protecting the abdomen of the experimental animal may be positioned on the opposite side of the anesthetic port 70, and coupled to the end of the upper plate 51.

FIG. 6C illustrates the upper plate 52 that may be used in intratracheal injection. Referring to FIG. 3, in intratracheal injection, the experimental animal is placed on the upper plate while lying down, unlike intrathecal injection and intravenous injection.

In intratracheal injection, since the drug substance needs to be directly injected into the trachea through the mouth of the experimental animal, the mouth of the experimental animal should be kept open during the injection process. Accordingly, in the intratracheal injection, the experimental animal restrainer of the present disclosure may be positioned at the bottom of the anesthetic port and further include an opening device 100 for opening the mouth of the experimental animal.

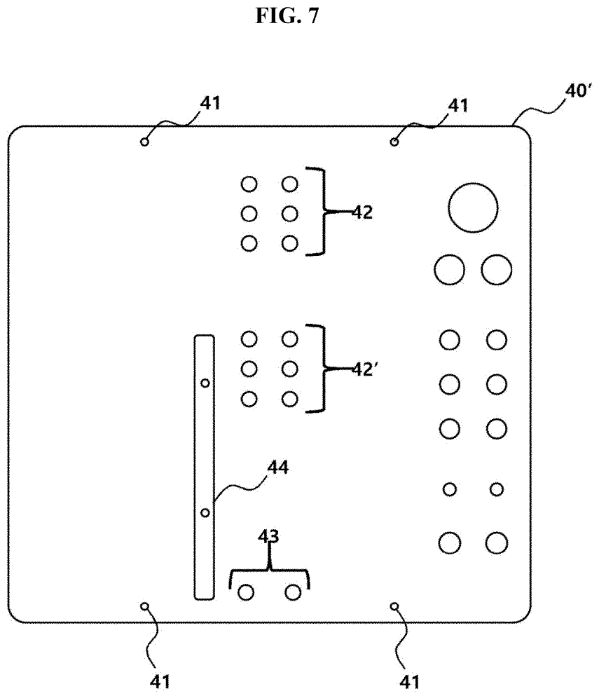

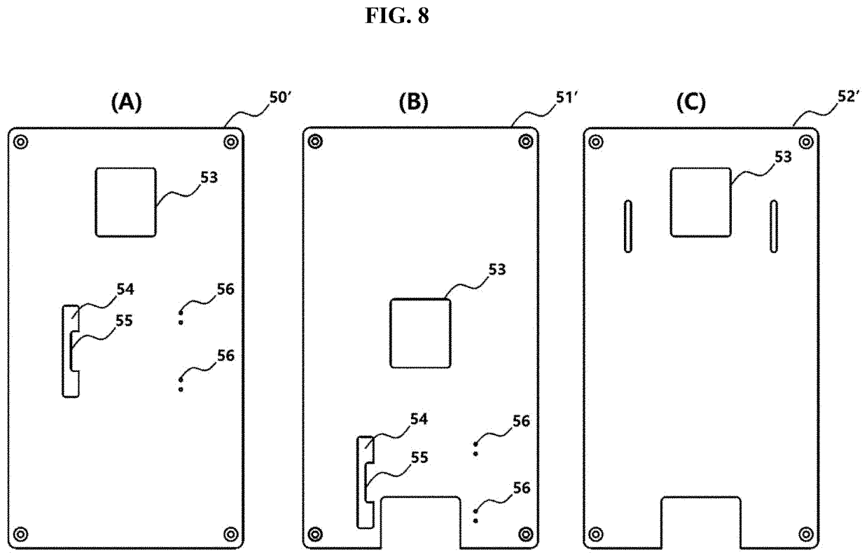

FIGS. 7 and 8 illustrate a lower plate 40′ and upper plates 50′, 51′, and 52′ according to yet another embodiment of the present disclosure.

The lower plate 40′ includes an upper plate coupling part 41 for coupling each of the upper plates 50′, 51′, and 52′, and may include anesthetic port fixing part coupling parts 42 and 42′ capable of coupling the anesthetic port fixing part 80 and a coupling part 43 capable of coupling the tail fixing part or the clip for protecting the abdomen of the experimental animal.

The coupling may be screw coupling or coupling using a magnet. In this case, at least one of the components to be coupled may include a magnet in a corresponding portion, and the other may include a metal piece. In addition, when all of the components to be coupled include the magnets, it is preferable to include magnets having different polarities.

The lower plate 40′ may include anesthetic port fixing part coupling parts 42 and 42′ at different positions. The coupling part 42 may be coupled with the anesthetic port fixing part in the intravenous injection or intratracheal injection, and the coupling part 42′ may be coupled with the anesthetic port fixing part in the intrathecal injection.

According to the administration method, appropriate upper plates 50′, 51′, and 52′ are coupled onto the lower plate 40′ and the anesthetic port fixing part may be fixed to the lower plate 40′ through an anesthetic port fixing part hole 53 of the upper plates 50′, 51′, and 52′.

In the intravenous injection or intratracheal injection, the fixing part 60 may be coupled to restrain the experimental animal placed on the upper plates 50 and 51.

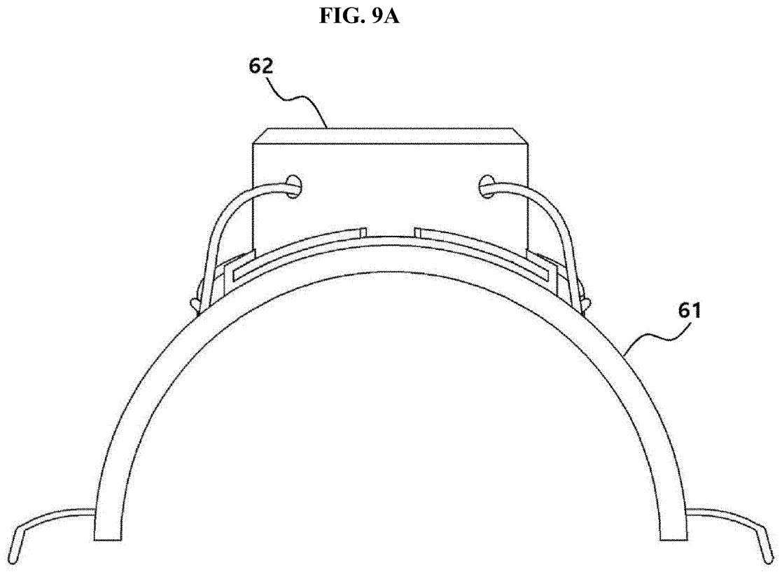

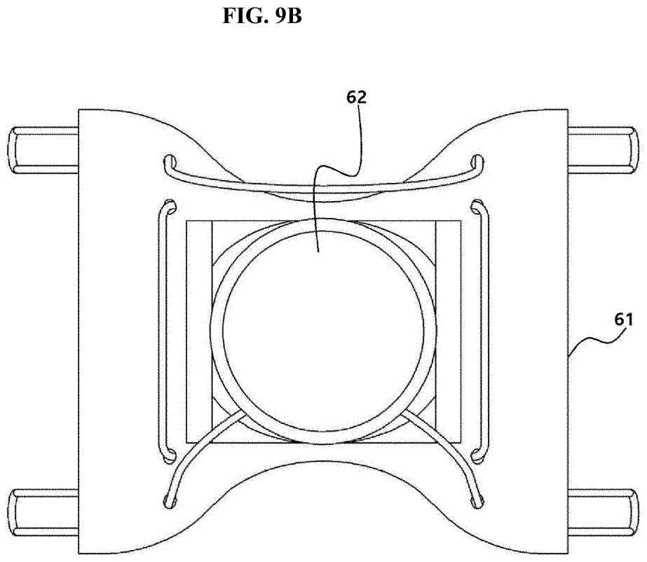

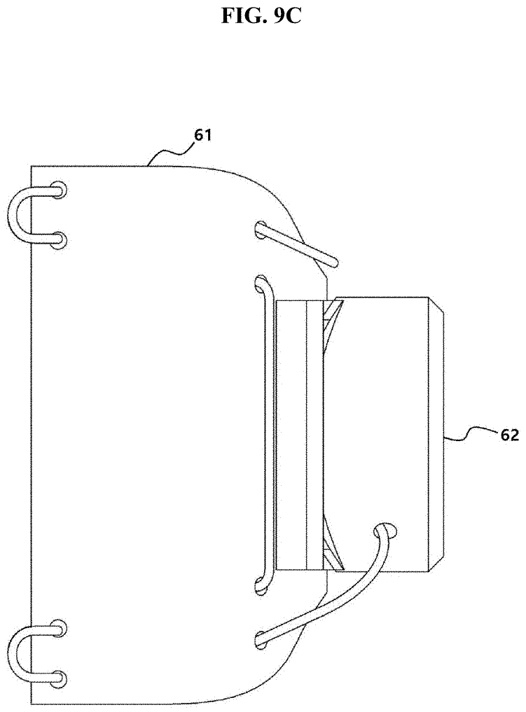

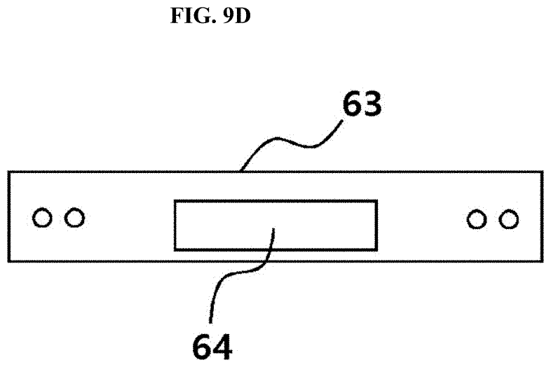

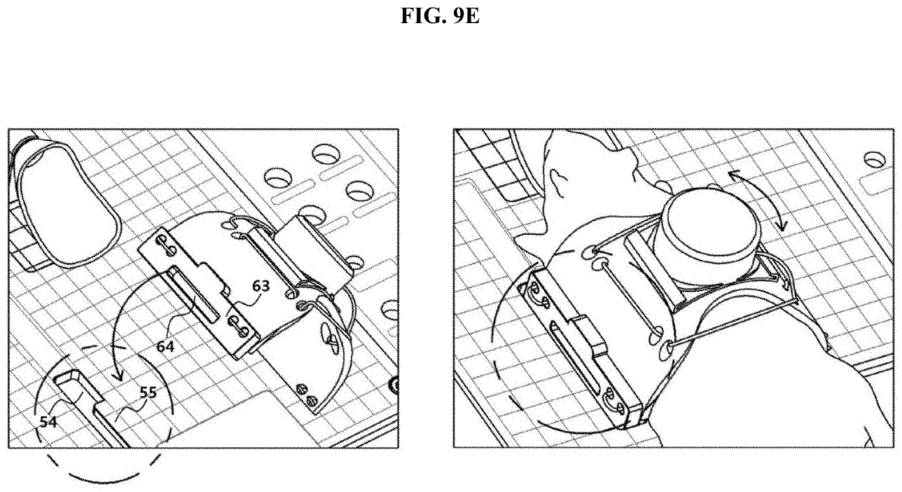

Referring to FIGS. 9A to 9E, the fixing part 60 may include a jacket 61 and a boa system 62. The jacket 61 serves to cover the body of the experimental animal, and the boa system 62 may restrain the experimental animals to the upper plates 50, 51, and 52. Here, the boa system 220 is a fastening type mainly used for shoes, etc. in which a string is tightened according to the rotation of a fixing dial by using the fixing dial and the string, and a detailed description thereof will be omitted. Accordingly, at least two or four fastening parts to which the string of the boa system 62 may be coupled may be formed on the upper plate.

The upper plates 50′, 51′, and 52′ according to yet another embodiment of the present disclosure include two boa system string coupling parts 56 and the coupling parts 56 may fix the string positioned at one side of the boa system. In the upper plates 50′, 51′, and 52′, a string fixing part groove 54 capable of accommodating the string fixing part 63 is formed in correspondence with the string coupling part 56, and a protrusion 55 capable of fixing the string fixing part 63 may be further included in the groove (see FIG. 8).

Referring to FIG. 9E, the string positioned at the other side of the boa system is coupled to the string fixing part 63 through the hole of the string fixing part 63, and the string fixing part 63 is seated on the string fixing part groove 54 and a recess 64 in the string fixing part is coupled with the protrusion 55 to fix the boa system to the upper plate.

By using the string fixing part, the other side may be freely opened and closed, so that it may be easier to fix the experimental animal to the boa system than when all four strings are fixed to the upper plate.

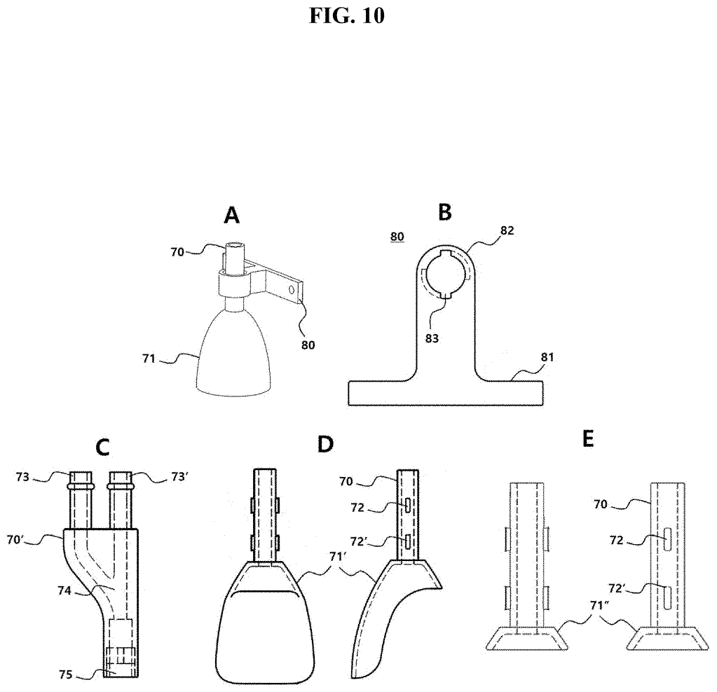

FIG. 10 illustrates the anesthetic port 70 and the anesthetic port fixing part 80. In the upper plates 50, 51, and 52 or the lower plate 40′, the anesthetic port fixing part 80 for fixing the hollow anesthetic port 70 to the upper plates 50, 51, and 52 or the lower plate 40′ may be coupled.

FIG. 10A illustrates the anesthetic port 70 coupled to the anesthetic port fixing part 80. The anesthetic port 70 may have a hollow cylindrical shape, one end of the anesthetic port 70 is positioned close to the face of the experimental animal, and the other end of the anesthetic port 70 may be connected with a hose (not illustrated) to which anesthetic gas may be supplied. Accordingly, the experimental animal may be kept in the anesthetic state by the anesthetic gas supplied from the anesthetic gas hose.

At one end of the anesthetic port 70, a parabolic head cover 71, a scoop-shaped head cover 71′, or a dish-shaped head cover 71″ capable of cover or holding the head of the experimental animal may be further included. When the head cover has the scoop shape, the head cover may be also referred to as the head holder. The head cover 71 provides an effect of concentrating the anesthetic gas on the experimental animal by positioning the head of the experimental animal inside.

The head covers 71 and 71′ may be mainly used in intrathecal injection or intravenous injection. In the case of the intratracheal injection, since the drug substance needs to be injected through the mouth of the experimental animal, in the case of using the head covers 71 and 71′, there may be inconvenience in the administration process, so that it is preferable to use the dish-shaped head cover 71″ in the intratracheal injection.

Preferably, the anesthetic port 70 is coupled to the anesthetic port fixing part 80, and the anesthetic port fixing part 80 is coupled to the upper center of the upper plates 50, 51, and 52 or the lower plate 40′. The coupling may be coupling using a magnet. In this case, at least one of the components to be coupled may include a magnet in a corresponding portion, and the other may include a metal piece. In addition, when all of the components to be coupled include the magnets, it is preferable to include magnets having different polarities.

FIG. 10B illustrates the anesthetic port fixing part 80 to which the anesthetic port 70 may be coupled. The anesthetic port fixing part 80 may include a coupling portion 81 capable of being coupled to the upper plates 50, 51, and 52 or the lower plate 40, and an anesthetic port coupling portion 82 capable of being vertically fixed to the coupling portion 81 and fixing the anesthetic port.

It is preferable that the anesthetic port is coupled to the anesthetic port coupling portion 82 to be horizontally disposed with the upper or lower plate. The anesthetic port coupling portion 82 may be configured in a curved hook shape or a hollow cylindrical shape as a portion to which the anesthetic port 70 is fixed, but is not limited thereto.

The anesthetic port coupling portion 82 having the hollow cylindrical shape may include a plurality of coupling grooves 83 capable of being coupled to the anesthetic port 70 on the inner surface thereof, and include coupling protrusions 72 and 72′ corresponding to the coupling grooves on the outer surface of the anesthetic port 70.

The anesthetic port fixing part 80 may be coupled to the upper plates 50, 51, and 52 or the lower plate 40′, and the anesthetic port 70 may be fixed by being fitted to the anesthetic port coupling portion 82. One side of the anesthetic port fixing part 80 may include a coupling protrusion for coupling with the upper plates 50, 51, and 52 or the lower plate 40′, and the upper plates 50, 51, and 52 may include a coupling groove at a portion corresponding to the coupling protrusion of the anesthetic port fixing part 80.

The position, shape, and size of the coupling protrusion and the coupling groove are not particularly determined, and may be variously applied in consideration of coupling strength, manufacturing process, and the like.

FIG. 10C illustrates an anesthetic port 70′ according to another embodiment. The anesthetic port 70 described above has a hollow cylindrical shape, and includes one anesthetic gas inlet and one anesthetic gas outlet. Preferably, the anesthetic gas inlet of the anesthetic port 70 may be connected to an anesthetic gas hose, and the anesthetic gas outlet may be coupled to the head covers 71, 71′ and 71″. Unlike this, FIG. 7C illustrates an anesthetic port 70′ comprising a plurality of anesthetic gas inlets 73 and 73′. The anesthetic gas inlets 73 and 73′ may be connected with anesthetic gas hoses for supplying different types of anesthetic gases. The different anesthetic gases introduced into the plurality of anesthetic gas inlets may be mixed with each other in a guide pipe 74 and discharged to the anesthetic gas outlet 75.

FIG. 10D illustrates a head cover 71′ according to another embodiment. The head cover 71′ has a scoop shape in which a part of the surface without the parabolic shape is opened. In this case, the position of the head of the experimental animal may be more accurately determined than the parabolic head cover 71 that completely covers the head of the experimental animal to help to maintain the anesthetic state of the experimental animal.

FIG. 10E illustrates a head cover 71″ according to another embodiment. The head cover 71″ has a dish shape with a cut-off parabolic shape. In this case, anesthesia may be performed without interfering with the position of the opening device during an intratracheal injection experiment, thereby helping to maintain the anesthetic state of the experimental animal.

The head covers 71, 71′, and 71″ and the anesthetic port 70 may be formed separately or may be formed integrally. When the head covers 71, 71′, and 71″ and the anesthetic port 70 are integrally formed, in the case where it is necessary to inject a plurality of gases through the anesthetic port 70, the anesthetic port 70 may also be coupled with the anesthetic port 70′ including a plurality of anesthetic gas inlets 73 and 73′. For coupling with the anesthetic port 70′, the anesthetic port 70 may include a plurality of coupling protrusions 72 and 72′, wherein one coupling protrusion may be coupled to the coupling groove of the anesthetic port fixing part 80 and the other coupling protrusion may be coupled to the coupling groove formed in the anesthetic gas outlet 75.

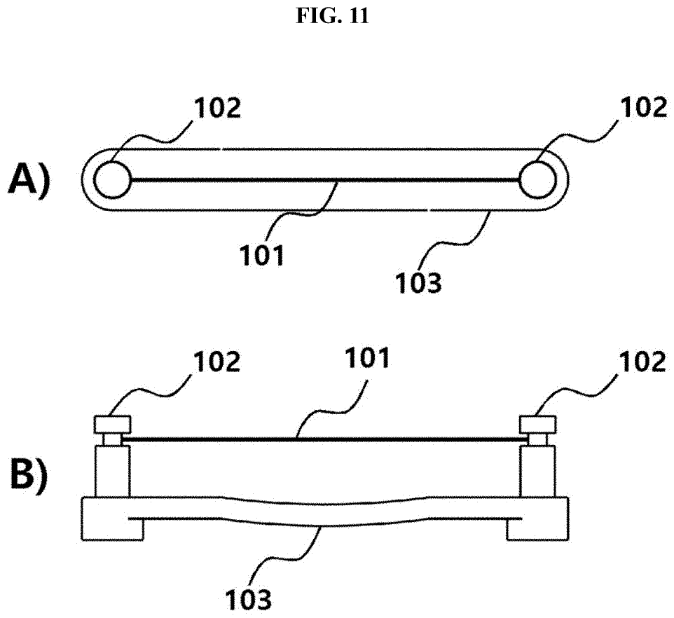

FIG. 11 illustrates the opening device 100 that may be used in intratracheal injection. The opening device 100 is fixed to the upper plate 52 to fix the teeth of the experimental animal, thereby helping to maintain the opened state of the mouth of the experimental animal.

Referring to FIG. 11, the opening device 100 includes a tooth fixture 101 for fixing the teeth of the experimental animal and a support 102 for positioning the tooth fixture on the coupling part 103. The support 102 may be positioned at both ends of the tooth fixture 101.

The tooth fixture 101 may be made of a thread or a thin rod, and may be made of other suitable materials for fixing the teeth of the experimental animal.

The support 102 may fix the tooth fixture 101 at both ends of the tooth fixture 101, and a pair of supporters 102 may be fixed to the coupling part 103. The coupling part 103 may be coupled to the upper plates 52 and 52′.

The upper plates 52 and 52′ may further include a vertical groove to which the coupling part 103 may be coupled. Accordingly, the opening device 100 may move up and down according to a size of the experimental animal to fix the teeth of the experimental animal at an appropriate position. The coupling may be coupling using a magnet. In this case, at least one of the components to be coupled may include a magnet in a corresponding portion, and the other may include a metal piece. In addition, when all of the components to be coupled include the magnets, it is preferable to include magnets having different polarities.

Since the experimental animal is placed on the upper plate in intratracheal injection, a head support 110 capable of supporting the head of the experimental animal may be further included. The head support 110 may not be used in the case of intrathecal injection and intravenous injection.

In the case of the head support 110, one side may include a coupling protrusion for coupling with the upper plate 52, and the upper plate 52 may include a coupling groove at a portion corresponding to the coupling protrusion of the head support 110. The position, shape, and size of the coupling protrusion and the coupling groove are not particularly determined, and may be variously applied in consideration of coupling strength, manufacturing process, and the like.

In intratracheal injection, the experimental animal restrainer of the present disclosure may further include tail holders 120 and 120′ capable of fixing the tail of the experimental animal. The tail holders 120 and 120′ may be positioned at an opposite side to the anesthetic port and fixed to the upper plates 52 and 52′ or the lower plate 40′.

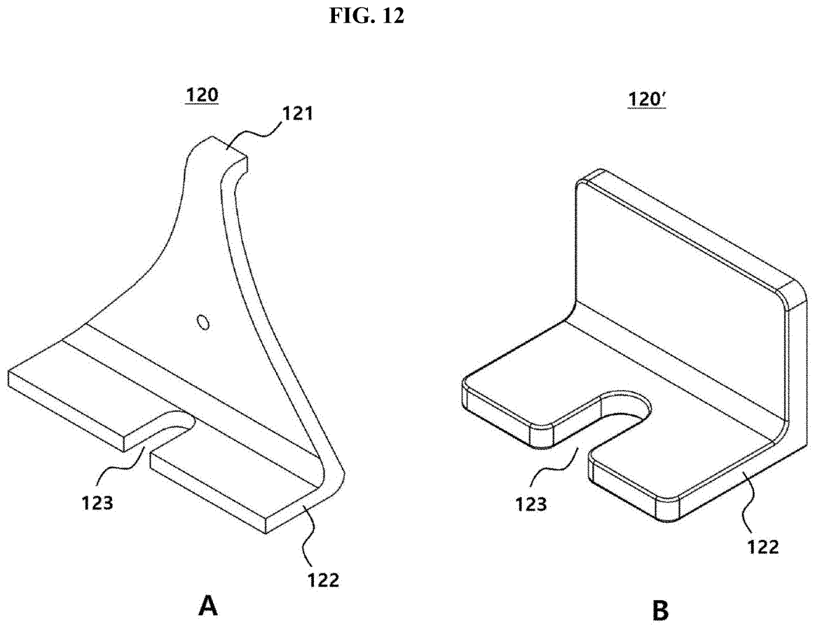

Referring to FIG. 12, the tail holder 120 may include a tail holder fixing part 121 that protrudes from one side so as to be fixed to the upper plates 52 and 52′ or the lower plate 40′, and a tail fixing part 122 that protrudes on the other side of the tail holder 120 in an opposite direction to the tail holder fixing part 121 and has a groove 123 in which the tail of the experimental animal may be positioned.

When the tail holder 120′ is fixed to the upper plates 52 and 52′ or the lower plate 40′ by a magnet, the tail holder 120′ may not include the tail holder fixing part 121.

The upper plate 52 may further include a vertical groove to which the tail holder 120 may be coupled. Accordingly, the tail holder 120 may move up and down according to a size of the experimental animal to fix the tail of the experimental animal at an appropriate position.

In the case of intratracheal injection, the fixing part 60 may be not used. Accordingly, a fastening part to which the string of the boa system 62 may be coupled may not be formed on the upper plate 52.

In an additional embodiment, the upper plates 50, 51, and 52 or the lower plate 40′ of the experimental animal restrainer of the present disclosure may further include an opening part capable of mounting experimental tools such as a tube or a syringe that may be used in an experiment. The opening part may be installed on both sides of the center on which the experimental animal is placed.

When the experimental tools used in the experiment are placed on the floor of the experiment bench, there is a risk of contamination, so that accurate experimental results cannot be obtained. It is possible to prevent the experimental tools from falling down or an administered material from being spilled.

In the present specification, the present disclosure has been mainly described with reference to limited embodiments, but various embodiments are possible within the spirit scope of the present disclosure. In addition, although not described, it will be understood that equivalent means are also combined as they are in the present disclosure. Therefore, the scope of the present disclosure should be determined by the appended claims.

What is claimed is:

1. An experimental animal restrainer applicable to various drug administration methods comprising:
a base;
a support of which one end is hinged to one side of the base so as to be rotatable with the base;
a fixing plate hinged to the other end of the support to be rotatable;
a lower plate of which one side is coupled to the fixing plate;
an upper plate of which one side is coupled to the other side of the lower plate and the other side is placed with an experimental animal with a tail; and
a hollow anesthetic port positioned on the upper portion of the upper plate or the lower plate; and
an anesthetic port fixing part for fixing the anesthetic port to the upper plate or the lower plate.

2. The experimental animal restrainer of claim 1, wherein the support and the fixing plate are folded at 180° with respect to the base plane.

3. The experimental animal restrainer of claim 1, further comprising:
a fixing part coupled with the upper plate to restrain the experimental animal placed on the upper plate.

4. The experimental animal restrainer of claim 3, wherein the fixing part includes a jacket covering the body of the experimental animal and a boa system for contacting the jacket with the upper plate.

5. The experimental animal restrainer of claim 4, wherein the boa system includes a string and a dial, a part of the string is fixed to the upper plate, and the other part is fixed to the upper plate by a string fixing part.

6. The experimental animal restrainer of claim 1, further comprising:
a clip for protecting the abdomen of the experimental animal which is positioned at an opposite side to the anesthetic port and coupled to the end of the upper plate or the lower plate.

7. The experimental animal restrainer of claim 1, wherein the anesthetic port has a hollow cylindrical shape, and includes one or more anesthetic gas inlets and one anesthetic gas outlet, and the anesthetic gas outlet is coupled with a head cover having a parabolic shape, a scoop shape or a dish shape capable of covering the head of the experimental animal.

8. The experimental animal restrainer of claim 1, wherein the anesthetic port fixing part includes
a coupling part capable of being coupled to the upper plate or the lower plate; and
an anesthetic port coupling part vertically fixed to the coupling part to fix the anesthetic port.

9. The experimental animal restrainer of claim 1, further comprising:
an opening device positioned below the anesthetic port to open the mouth of the experimental animal.

10. The experimental animal restrainer of claim 9, wherein the upper plate or lower plate further includes a vertical groove for fixing the opening device, and
the opening device includes a rod-shaped tooth fixture for fixing the teeth of the experimental animal;
a tooth fixture coupling part for fixing the tooth fixture to the upper plate or the lower plate; and
a tooth fixture support positioned at both sides of the tooth fixture and disposed at the coupling part.

11. The experimental animal restrainer of claim 1, further comprising:
a tail holder positioned at an opposite side to the anesthetic port and fixed to the upper plate or the lower plate to fix the tail of the experimental animal.

12. The experimental animal restrainer of claim 10, wherein one side of the tail holder includes a tail holder fixing part for fixing the tail holder to the upper plate or the lower plate; and
the other side includes a tail fixing part that protrudes in an opposite direction to the tail holder fixing part and has a groove in which the tail of the experimental animal is positioned.

13. The experimental animal restrainer of claim 1, wherein the experimental animal restrainer is used for intravenous injection, intrathecal injection and intratracheal injection.
